(19) United States
(12) Patent Application Publication
(10) Pub. No.: US 2005/0254449 A1
(43) Pub. Date: Nov. 17, 2005

(54) Method for allocating radio communication resources in a self-organising radio communications system

(76) Inventors: Rudiger Halfmann, Otterberg (DE); Andreas Kramling, Bonn (DE); Hui Li, Munchen (DE); Matthias Lott, Neuried (DE); Egon Schulz, Munchen (DE); Matthias Siebert, Aachen (DE); Martin Weckerle, Ulm (DE)

Correspondence Address: STAAS & HALSEY LLP, SUITE 700, 1201 NEW YORK AVENUE, N.W., WASHINGTON, DC, 20005, US

(21) Appl. No.: 10/524,293

(22) PCT Filed: Aug. 6, 2003
(86) PCT No.: PCT/EP03/08716

§ 371 Date: Feb. 11, 2005

(30) Foreign Application Priority Data
Aug. 13, 2002 (EP) 02255631.0

(51) Int. Cl. H04Q 7/00

(52) U.S. Cl. 370/328

(57) ABSTRACT

Radio communication resources are allocated in an at least partially self-organising radio communications system having several user stations and at least one central entity for organizing the allocation of radio communication resources, in addition to a corresponding radio communications system. Resources for direct communication between at least two respective user stations are allocated repeatedly at least partly by the central entity.

### CROSS REFERENCE TO RELATED APPLICATIONS

This application is based on and hereby claims priority to European Application No. 02255631.0 filed on Aug. 13, 2002, the contents of which are hereby incorporated by reference.

### BACKGROUND OF THE INVENTION

1. Field of the Invention

The invention relates to a method for allocating radio communication resources in an at least partially self-organizing radio communication system having a plurality of user stations or a plurality of user stations.

2. Description of the Related Art

Communication systems have a great significance in both the economic and the private sectors. Major efforts are in place to combine cable-bound communication systems with radio communication systems. The hybrid communication systems coming into being result in an increase in the number of services that are made available, but they also enable a greater degree of flexibility on the communication side. Devices are thus being developed which can use different systems (multi homing). In this situation, great significance attaches to the radio communication systems as a result of the mobility they enable for the users.

In radio communication systems, information (for example voice, graphical information, video information, SMS [Short Message Service] or other data) is transmitted with the aid of electromagnetic waves over a radio interface between sending and receiving station (base station and user station respectively). In this situation, the emission of the electromagnetic waves takes place using carrier frequencies which lie in the frequency range provided for the respective system. Frequencies of 900, 1800 and 1900 MHz are used for the GSM mobile radio system (Global System for Mobile Communication) which has been introduced. These systems essentially convey voice, fax and short messages SMS (Short Message Service) as well as digital data.

For future mobile radio systems using CDMA or TD/CDMA transmission methods, such as UMTS (Universal Mobile Telecommunication System) or other third generation systems for example, frequencies in the frequency range of about 2000 MHz are provided. These third generation systems are being developed with the objectives of giving worldwide radio coverage, offering a wide spectrum of services for data transmission purposes, and above all providing flexible management of the capacity of the radio interface which in the case of radio communication systems is the interface having the lowest level of resources. With regard to these radio communication systems, it should above all be possible as a result of the flexible management of the radio interface for a user station to be able to send and/or receive a large quantity of data at a high data transfer rate when required.

Access by stations to the common radio communication resources of the transmission medium, such as for example time, frequency, service or space, is regulated by multiple access (MA) methods in respect of these radio communication systems.

In the case of time division multiple access (TDMA) methods, each send and receive frequency range is divided into time slots, whereby one or more cyclically repeated time slots are allocated to the stations. By using TDMA, the radio communication resource Time is separated on a station-specific basis.

In the case of frequency division multiple access (FDMA) methods, the entire frequency range is divided into narrowband ranges, whereby one or more narrowband frequency ranges are allocated to the stations. By using FDMA, the radio communication resource Frequency is separated on a station-specific basis.

In the case of code division multiple access (CDMA) methods, the service/information to be transmitted is coded on a station-specific basis by a spreading code having a large number of individual so-called chips, as a result of which the service to be transmitted is spread randomly over a wide frequency range, depending on the code. The spreading codes used by different stations within a cell/base station are mutually orthogonal in each case or are essentially orthogonal, as a result of which a recipient recognizes the signal service intended for it and suppresses other signals. By using CDMA, the radio communication resource Service is separated on a station-specific basis by spreading codes.

In the case of orthogonal frequency division multiplexing (OFDM) methods, the data is conveyed on a broadband basis, whereby the frequency range is divided into equidistant orthogonal subcarriers such that the simultaneous phase displacement of the subcarriers opens up a two-dimensional data flow in the time-frequency range. By using OFDM, the radio communication resource Frequency is separated on a station-specific basis by orthogonal subcarriers. The grouped data symbols transferred during one unit of time on the orthogonal subcarriers are referred to as OFDM symbols.

The multiple access methods can be combined. Thus, many radio communication systems use a combination of the TDMA and FDMA methods, whereby each narrowband frequency range is subdivided into time slots.

For the aforementioned UMTS mobile radio system, a distinction is made between a so-called FDD mode (Frequency Division Duplex) and a TDD mode (Time Division Duplex). The TDD mode is characterized in particular by the fact that a common frequency range is used both for signal transmission in the upward direction (UL—Uplink) and also in the downward direction (DL—Downlink), whereas the FDD mode uses a different frequency range in each for the two transmission directions.

In second and/or third generation radio communication links information can be transmitted in circuit switched (CS) or packet switched (PS) fashion.

The link between the individual stations is effected by way of a radio communication interface. Base station and radio network control facility are normally components of a base station subsystem (RNS Radio Network Subsystem). A cellular radio communication system generally has a plurality of base station subsystems which are connected to a core network (CN). In this situation, the radio network control facility of the base station subsystem is generally connected to an access facility of the core network.

In addition to these hierarchically organized cellular radio communication systems, self-organizing wireless radio communication systems—so-called ad hoc systems for example—are increasingly gaining in significance, also in cellular radio communication systems.

A fundamental problem with self-organizing wireless radio communication systems is posed by the organization and control of the allocation of the radio communication resources. Radio communication resources for transmitting messages are characterized by the fact that they represent physically separate transmission units which are orthogonal with respect to one another or are essentially orthogonal in respect of the frequency range and/or the time range and/or a code.

In cellular radio communication systems the allocation of the radio communication resources is monitored and controlled by a central entity. Frequently, in cellular radio communication systems such as GSM or UMTS for example, the communication only takes place between the mobile terminal devices and the central entity.

In addition, self-organizing radio communication systems also generally permit direct communication between mobile terminal devices and do not necessarily have a central entity which controls the access to the transmission medium.

For example, in radio communication systems in accordance with the IEEE 802.11 standard no centrally organized allocation of radio communication resources is provided. The MAC protocol used (MAC Medium Access Control Protocol) for organizing the access to the transmission medium is decentralized, which means that no optimum usage of the available resources is possible.

The use of central entities in self-organizing radio communication systems for controlling medium access (centralized medium access control) and thus the allocation of resources, such as are used in HIPERLAN/2 and Bluetooth for example, enables a more targeted and thus more efficient usage of the resources. In this situation, a plurality of user stations or terminal devices are assigned to one central entity. The concepts used by the central entity for organizing the allocation of resources take into consideration the fact that there is no multiple allocation of any resource either for the communication between this central entity and different mobile terminal devices or for the direct communication between different mobile terminal devices. This is because multiple usage of the same resource during the transmission of messages between different pairs of communication partners generally results in interference effects or to mutual disruption affecting the respective transmissions.

In cellular mobile radio systems, as a result of the reuse of the same frequencies in different cells (frequency reuse) it is possible to achieve multiple usage of the same resources when viewed on a system-wide basis. This is known for example from: J. Zander, M. Frodigh, “Capacity Allocation and Channel Assignment in Cellular Radio Systems Using Reuse Partitioning”, Electronics Letters, Vol 28, No. 5, 1992, pp. 438-440; or R. Borndörfer, A. Eisenblätter, M. Grötschel, A. Martin, “Frequency assignment in cellular phones networks”, Annals of Operation Research, Vol. 76, 1998.

If the same frequency is reused in each cell, considerable interference effects can occur in particular for user stations or mobile terminal devices (mobile terminals, MTs) at the cell edge. For this reason, so-called clusters are frequently formed in which a plurality of cells (3, 7, . . . for example) are grouped together in which no frequency is used twice. The number of cells grouped together in a cluster is referred to as the cluster size. If this cluster structure is repeated by an appropriate spatial arrangement across the entire cellular system, then it is possible to guarantee that two cells in which the same frequency is used are spatially separated from each other by at least one cell in which a different frequency is used (in the case where the cluster size equals 3, this is exactly one cell).

In self-organizing networks in accordance with IEEE 802.11 Standard, see for example in this connection: “Local and metropolitan area networks—Specific requirements—Part 11: Wireless LAN Medium Access Control (MAC) and Physical Layer (PHY) Specifications”, IEEE P802.11/D10, 1999, the allocation or assignment of resources for the communication between user stations takes place without the support of a central entity. The MAC protocol used for this purpose is based on the CSMA/CA multiple access method (Carrier Sense Multiple Access with Collision Avoidance).

If a transmission is to be carried out between a station A (sender) and a station B (receiver), then A initially monitors the frequency on which the transmission is to take place. If the transmission medium is free for a specified period (Distributed Inter Frame Space, DIFS), in other words the frequency is not currently being used for another transmission, then A sends off a Request to Send (RTS) Control Frame containing information about the quantity of data to be transmitted. If the remote station B responds with a Clear to Send (CTS) Control Frame, then the transmission can take place. If A does not receive the CTS Control Frame within a certain period of time, then after a random waiting time A will attempt once again to effect a transmission. When B has correctly received the data from A, B issues an acknowledgment packet (ACK packet).

In order to avoid collisions during transmissions between a plurality of stations, any other station C which receives both the RTS Control Frame from A and also the CTS Control Frame from B may not make use of the transmission medium until such time as it has also received the ACK packet from B. If C receives only the RTS Control Frame from A, then C may not make use of the transmission medium during the period of time which is required in order to transmit the quantity of data specified in the RTS Control Frame from A to B. If C receives only the CTS Control Frame from B, then C must wait until it also receives the ACK packet issued by B. In this manner, the situation is prevented whereby stations which lie within range of A and/or B and which could interfere with the transmission between A and B through usage of the same resource are not allocated the resource which is used by A and B.

If in addition a transmission is to take place between two stations D and E and if neither D nor E receives neither the RTS Control Frame from A nor the CTS Control Frame from B, then the transmission can take place in the same fashion as the transmission between A and B. D and E are not situated within range of A and B and therefore do not mutually interfere with the transmissions between A and B and also between D and E. In this case, the same resource is coincidentally used twice. A multiple assignment of resources is thus possible in systems in accordance with the IEEE 802.11 Standard. This is not planned, however, as a result of which the available resources are not efficiently used.

In HIPERLAN/2, which is described for example in: “Broadband Radio Access Networks (BRAN); HIPERLAN Type 2; Data Link Control (DLC) Layer; Part 1: Basic Data Transport Functions”, ETSI TS 101 761-1, 2000, central entities are used for organizing the allocation of resources. If a link exists to a fixed network, then this entity is known as the Access Point (AP). If no infrastructure exists, then a Central Controller (CC) assumes the functions of the Access Point. The Access Point or Central Controller (AP/CC) thus assumes the control of radio communications between all user stations which lie within range of the Access Point or Central Controller and are assigned to this entity.

The organization of the transmission in HIPERLAN/2 is TDMA-based (TDMA Time Division Multiple Access), whereby the resource made available for the transmission is divided into so-called MAC Frames each having a duration of 2 ms, which is illustrated in detail in FIG. 1. Further reference can be made in this context to: “Broadband Radio Access Networks (BRAN); HIPERLAN Type 2; Data Link Control (DLC) Layer; Part 1: Basic Data Transport Functions”, ETSI TS 101 761-1, 2000.

A MAC Frame begins with the Broadcast Channel BCH which contains the network ID and a frame synchronization sequence as well as information about the starting time points for the Frame Channel FCH and the Random Channel RCH. With the following Frame Channel FCH, information is made available for each user station assigned to an Access Point or Central Controller regarding the point in time in the Downlink Phase (DL Phase) at which the user station must receive data from the Access Point or Central Controller and the point in time in the Uplink phase (UL Phase) at which it may send data to the Access Point or Central Controller. Direct communication between user stations (MT) takes place in the Direct Link phase (DiL Phase). This is described in further detail for example in: “Broadband Radio Access Networks (BRAN); HIPERLAN Type 2; Data Link Control (DLC) Layer; Part 4: Extension for Home Environment”, ETSI TS 101 761-4, 2000.

The points in time for the commencement of the respective transmissions in the DiL Phase are likewise given by the Frame Channel FCH. User stations can register the requirement for capacity for the transmission of data in the DiL Phase or in the UL Phase by issuing a ‘capacity request’ in one time slot of the RCH. In the following MAC Frame, they are informed by way of the Access Feedback Channel ACH as to whether the required resources are made available for them. All points in time at which a transmission begins in the DiL, or DL and UL phase are coordinated such that no transmission takes place simultaneously between two communication partners which are assigned to the same Access Point or Central Controller. This means that no resource is subject to multiple simultaneous usage for all transmissions between user stations and their Access Point or Central Controller as well as for the direct transmissions between user stations controlled by the respective Access Point or Central Controller. Multiple allocations of resources are possible in situations when user stations are assigned to different Access Points or Central Controllers. In this case, the same transmission time periods can be defined at random for their respective user stations by the respective Access Points or Central Controllers. If user stations which are assigned to different Access Points or Central Controllers are mutually in range, then mutual disruption to the transmissions can result in this case.

### SUMMARY OF THE INVENTION

An object of the invention is to set down a method and a radio communication system of the type mentioned at the beginning which enable economical usage of the radio communication resources or improved usage of the radio communication resources.

According to one aspect of the invention, resources for a direct communication between at least two user stations in each case are at least partially allocated on a multiple basis by at least one central entity.

It is proposed that the resource allocation occurring during direct communication between user stations in self-organizing networks can be monitored and controlled by a central entity. An entity of this type can be a wireless access point (AP) to a backbone network or a fixed/mobile Central Controller (CC). The APs/CCs control the radio medium and thus the communication between AP/CC and the user stations assigned to them, and also the communication between the user stations.

The invention is based on the idea of achieving a more efficient level of usage of the available resources, effecting multiple usage of resources in self-organizing radio communication systems during direct communication between mobile terminal devices, when the allocation of these resources is monitored and controlled by a central entity. In this situation, the transmissions between the mobile terminal devices which use the same resource may not be impaired by the interference which is to be anticipated.

Provision is therefore advantageously made whereby at least one central entity allocates the resources on a multiple basis in situations when the direct communication between at least two user stations communicating with one another in each case while using the same resources meets certain quality requirements. The quality requirements can be fixed or variable.

It is particularly advantageous if on the one hand at least two first user stations communicating with one another while using the same resources and on the other hand at least two second user stations communicating with one another while using the same resources are in each case situated in different areas of the radio communication system, between which essentially no interference exists during the communication while using the resources.

The invention utilizes the fact that, in a self-organizing wireless radio communication system which permits direct communication between user stations or mobile terminal devices and in which the allocation of the radio communication resources is organized by a central entity, radio communication resources are used more efficiently as a result of the fact that they are allocated on a multiple basis by the central entity for the direct communication between user stations, in other words they are used by the user stations as long as the interference situation permits this without impairing the quality of the respective transmission between the user stations. This is possible in the situation when the user stations communicating directly with one another are spatially so far apart or are otherwise separated from other user stations which are communicating with one another and using the same resource with the result that for example no significant interference occurs on account of the radio field attenuation, shading or other topology dependent propagation attributes. The decision about the multiple allocation of the same resource is accordingly based in particular on the previously determined knowledge of the interference situation in which each user station would find itself in the event of multiple usage of a resource.

The user stations can at least partially report accessible user stations to the at least one central entity for a direct radio communication. In this situation, this information obtained about the interference situation for the user stations is delivered to the central entity, in other words normally to the Access Point or Central Controller respectively, using suitable protocols.

By exchanging the information about the interference situations of the individual user stations between the Access Points over the backbone network, by way of example, it is possible to achieve optimum multiple usage of the available resources throughout the system.

The central entity knows the interference situation in which each of its user stations would find itself if a plurality of user stations were to use the same resource.

This information can be notified to the central entity by the user stations themselves, for example. Each user station identifies its accessible neighbors and reports this information to the central entity. The central entity thus has knowledge of which user stations can access one another, in other words can communicate directly with one another, and which user stations will cause mutual disruption in the case of simultaneous resource usage if they do not wish to communicate with one another. The central entity therefore also has knowledge as to which of its user stations are not able to access one another and thus do not cause mutual disruption in the event of direct communication. If the requirement for a plurality of direct radio links between any two user stations or a group of user stations is reported by the user stations, then duplicate allocation of resources can be carried out. In this situation, the direct communication between two user stations or a plurality of user stations (multicast) is organized by the controlling station (AP/CC) or the central entity.

The multiple allocation of resources in the DiL can for example in the case of HIPERLAN/2 be implemented in a simple manner whereby the same transmission time point is specified in the FCH for different DiLs which are to use the same resource. As a result, the corresponding transmissions take place simultaneously in the DiL.

As a result of the multiple usage of the same resource, the spectral efficiency of the system is increased. Furthermore, the proposed solution can also be used in order to improve the spectral efficiency in cellular systems. If resources are reused in adjacent cells in cellular systems on the basis of the prior art, this can result in interference effects between user stations which are assigned to different cells. The proposed method means that user stations which can cause mutual disruption in the event of shared usage of the same resource are not prevented from using the same resources. By exchanging the information between different Access Points over the backbone network about the interference situations of the user stations controlled by the Access Points, it is possible to achieve optimum multiple usage of the available resources throughout the system, regardless of whether a cellular network or a non-cellular network is present.

According to one aspect of the invention, in order to allocate radio communication resources in a cellular radio communication system having a plurality of user stations, whereby the radio communication system has at least one central entity for organizing the allocation of radio communication resources, provision can be made whereby user stations at least partially report accessible user stations to at least one central entity for a direct radio communication.

The radio communication system according to one aspect of the invention has a plurality of user stations and at least one central entity for organizing the allocation of radio communication resources. Resources are allocated on a multiple basis at least partially by the at least one central entity for a direct communication between at least two user stations.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a data format diagram of a MAC frame structure on the basis of the prior art,

FIG. 2 is a schematic diagram of an example of a radio communication system according to the invention,

FIG. 3 is a data format diagram of an example of a MAC frame structure relating to the radio communication system according to the invention in accordance with FIG. 2,

FIG. 4 is a data format diagram of a further example of a MAC frame structure relating to the radio communication system according to the invention in accordance with FIG. 2,

FIG. 5 is a schematic diagram of an example of a cellular radio communication system according to the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

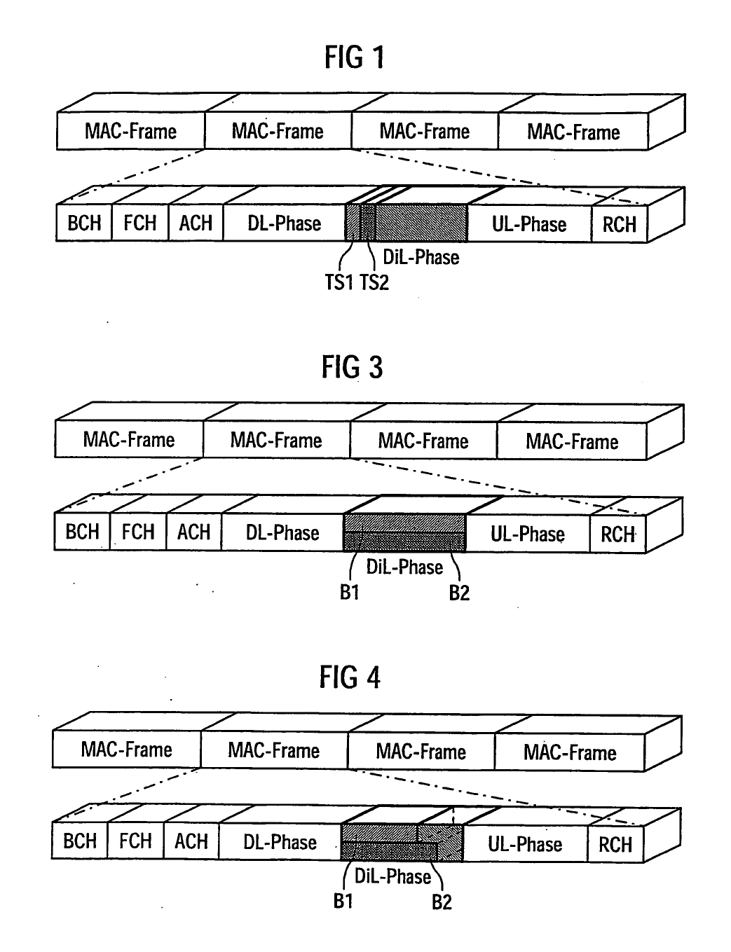

FIG. 1 has already been described in detail above. Different time slots TS1 and TS2 are marked in the illustrated example in the DiL phase for the direct communication between two different communication partners in each case.

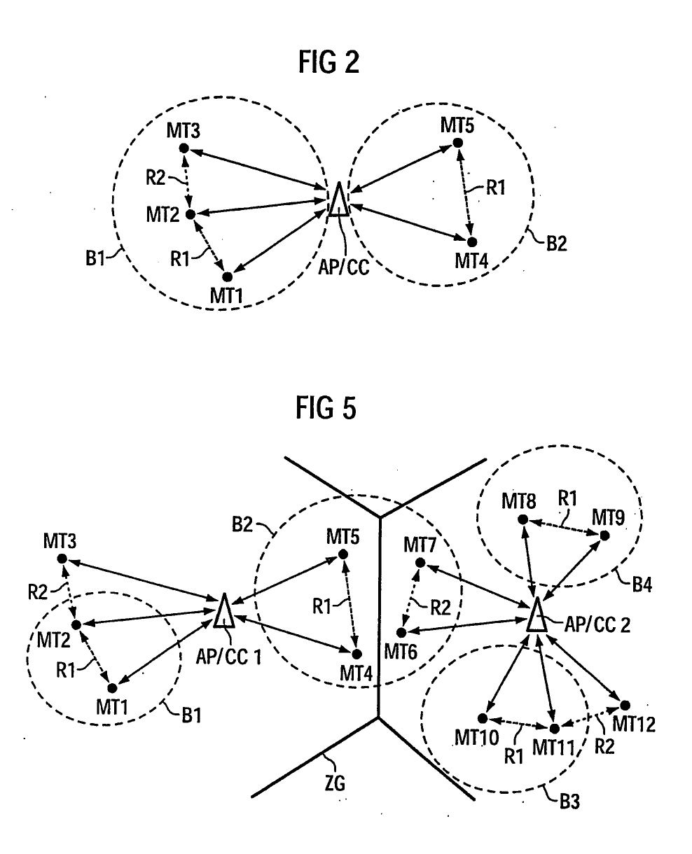

FIG. 2 shows a simple example of a radio communication system according to the invention. The user stations MT1, MT2 and MT3 are situated in area B1. The user stations MT4 and MT5 are located in the area B2 which is separated spatially from area B1. Both for the direct communication between the user stations MT1 and MT2 and also for the direct communication between the user stations MT4 and MT5 the central entity AP/CC has allocated the resource R1. Contrary to this, it has allocated the resource R2 for the direct communication between the user stations MT2 and MT3.

FIG. 3 shows an example of the structure of a MAC frame, where the same time slot is allocated simultaneously for the communication between two different MT pairs. One pair of user stations is situated for example in area B1 and another pair of user stations is situated for example in area B2. In this situation, the duration of the simultaneous transmission need not necessarily be of the same length, as is shown in FIG. 4.

FIG. 5 shows the corresponding application of an idea according to the invention in cellular systems. Cell boundaries ZG are indicated. The user stations MT1, MT2, MT3, MT4, MT5, MT6, MT7, MT8, MT9, MT10, MT11, MT12 are located in the four areas B1, B2, B3 and B4. In this case, user station MT1 sends to user station MT2, user station MT5 sends to user station MT4, user station MT9 sends to user station MT8, and user station MT11 sends to user station MT10, using the same resource R1 without the transmissions causing any mutual disruption. In addition, communication takes place between user stations MT3 and MT2, MT6 and MT7, MT11 and MT12, likewise using a same resource, namely the resource R2. This multiple resource usage also does not cause any mutual disruption. The central entities AP/CC 1 and AP/CC 2 organize the allocation of the radio communication resources, including the radio communication resources R1 and R2 which are used on a multiple basis.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-8. (canceled)

9. A method for allocating radio communication resources in an at least partially self-organizing radio communication system having a plurality of user stations and at least one central entity for organizing allocation of radio communication resources, comprising:
allocating resources for a direct communication between at least two user stations in each case on a multiple basis at least partially by the at least one central entity.

10. A method according to claim 9, wherein said allocating of the radio communication resources on a multiple basis is performed by the at least one central entity when the direct communication between at least two user stations using the same resources meets certain quality requirements.

11. A method according to claim 10, wherein the radio communication resources are allocated on a multiple basis for at least two first user stations communicating with one another while using the same resources and at least two second user stations communicating with one another while using the same resources that are in each case situated in different areas of the radio communication system, between which substantially no interference exists during the direct communication while using the same resources.

12. A method according to claim 11, wherein the at least two user stations at least partially report accessible user stations to the at least one central entity for a direct radio communication.

13. A method according to claim 12, wherein the at least partially self-organizing radio communication system is a cellular radio communication system.

14. A radio communication system having a plurality of user stations, comprising:
at least one central entity at least partially organizing allocation of radio communication resources on a multiple basis for a direct communication between at least two user stations in each case.

15. A radio communication system according to claim 14, wherein said at least one central entity receives reports from the user stations at least partially indicating accessible user stations for a direct radio communication.

16. A radio communication system according to claim 15, wherein the radio communication system at least partially exhibits a cellular structure.
